(19) United States
(12) Patent Application Publication
(10) Pub. No.: US 2009/0237859 A1
(43) Pub. Date: Sep. 24, 2009

(54) METHOD FOR MANUFACTURING MONOLITHIC CERAMIC ELECTRONIC COMPONENT AND MONOLITHIC CERAMIC ELECTRONIC COMPONENT

(75) Inventors: Daisuke NAKAMURA, Yasu-shi (JP); Yukio YOSHINO, Otsu-shi (JP); Yasuo FUCHI, Higashiomi-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: Murata Manufacturing Co., Ltd., Nagaokakyo-shi (JP)

(21) Appl. No.: 12/482,630

(22) Filed: Jun. 11, 2009

Related U.S. Application Data
(63) Continuation of application No. PCT/JP2007/072365, filed on Nov. 19, 2007.

(30) Foreign Application Priority Data
Dec. 12, 2006 (JP) 2006-334328

(51) Int. Cl. H01G 4/30; C04B 35/64

(52) U.S. Cl. 361/301.4; 156/89.12

(57) ABSTRACT

In a method for manufacturing a monolithic ceramic electronic component, metal thin-films to be processed into internal electrodes are formed on green ceramic sheets and include first metal particles and second metal particles that are more oxidizable than the first metal. The internal electrodes are formed in a firing step such that the second metal particles located near the interfaces between the metal thin-films and the green ceramic sheets are selectively oxidized and the second metal particles located in inner portions of the metal thin-films are deposited outside the metal thin-films and oxidized such that oxide layers including the oxidized second metal particles are formed along the interfaces and the first metal particles are sintered such that the first metal particles grow along the oxide layers.

### BACKGROUND OF THE INVENTION

1. Field of the Invention

The present invention relates to methods for manufacturing monolithic ceramic electronic components and monolithic ceramic electronic components. Particularly, the present invention relates to a method for manufacturing a monolithic ceramic electronic component including internal electrodes formed by a thin film-forming process and to a monolithic ceramic electronic component manufactured by the method.

2. Description of the Related Art

A conventional technique is disclosed in Japanese Unexamined Patent Application Publication No. 2000-243650. Japanese Unexamined Patent Application Publication No. 2000-243650 discloses a monolithic ceramic capacitor including internal electrodes that are formed by a thin film-forming process such as a vapor deposition process. The internal electrodes have an average thickness of 0.3 μm to 1.0 μm after firing. Since the internal electrodes have such a small thickness, the monolithic ceramic capacitor has an increased capacitance although the monolithic ceramic capacitor is relatively compact. However, the internal electrodes, which are formed by the thin film-forming process, may cause the problems described below.

FIGS. 4(1) and 4(2) are figures illustrating various problems and show a region of a monolithic ceramic capacitor that includes internal electrodes in cross section.

FIG. 4(1) shows a portion of a green compact 3 which is unfired and which is obtained such that a plurality of green ceramic sheets 2 having metal thin-films 1 formed by the thin film-forming process are stacked and pressed. The green compact 3 is fired. Due to the firing step, a sintered compact 4 is obtained as shown in FIG. 4(2). The sintered compact 4 includes internal electrodes 5 defined by the metal thin-films 1 and ceramic layers 6 defined by the green ceramic sheets 2. FIG. 4(2) schematically illustrates the internal electrodes 5, which cause the problem described below.

Usually, metal particles that form the metal thin-films 1 adhere to each other to grow into larger granules when the metal thin-films 1 are heated to a temperature greater than or equal to the sintering temperature of the metal particles in the firing step. Since an increase in the number of contacts between the metal particles causes the growth of the metal particles and a reduction in the size of the metal particles increases the specific surface area thereof, the particle growth is likely to occur at the beginning of sintering.

Where the metal thin-films 1, which are usually formed by the thin film-forming process, are formed by, for example, a vapor deposition process, the metal particles have a size corresponding to that of a metal atom or that of a cluster of several metal atoms. The metal particles are extremely likely to grow because of the heat applied to the metal thin-films 1 in the firing step. Thus, the metal thin-films 1 are likely to be distorted by various external forces, such as the surface tension of the metal particles and the sintering shrinkage of the ceramic sheets.

Therefore, the internal electrodes 5 are readily broken into beads during the particle growth in the firing step as shown in FIG. 4(2). That is, a beading phenomenon is likely to occur because the wettability between the ceramic layers 6 and the internal electrodes 5 is relatively low. The breakage of the internal electrodes 5 produces portions in which the internal electrodes 5 are not formed where the internal electrodes 5 should be formed. Thus, the coverage of the internal electrodes 5 is relatively low. This causes a problem in that the monolithic ceramic capacitor has a reduced capacitance gain. Furthermore, the breakage of the internal electrodes 5 causes an increase in the thickness T of the internal electrodes 5. This reduces the advantages obtained by forming the internal electrodes 5 by the thin film-forming process.

If the thickness of each ceramic layer 6 is reduced to 1 μm or less because of a recent trend toward thin film stratification, the breakage of the internal electrodes 5 may cause a problem in that the internal electrodes 5 sandwiching the ceramic layer 6 break through the ceramic layer 6 and therefore are short-circuited.

The above-described problems are not limited to the monolithic ceramic capacitor and also occur in monolithic ceramic electronic components including similar internal electrodes.

### SUMMARY OF THE INVENTION

To overcome the problems described above, preferred embodiments of the present invention provide a method for manufacturing a monolithic ceramic electronic component which increases the coverage of the internal electrodes and a monolithic ceramic electronic component manufactured by the method.

A method for manufacturing a monolithic ceramic electronic component according to a preferred embodiment of the present invention includes a step of preparing green ceramic sheets, a metal thin film-forming step of forming metal thin-films, to be formed into internal electrodes, on the green ceramic sheets by a thin film-forming process, a step of preparing a green compact such that the green ceramic sheets having the metal thin-films are stacked and pressed; and a firing step of firing the green compact.

In a preferred embodiment of the present invention, the metal thin-films are formed in the metal thin-film-forming step such that first metal particles and second metal particles are mixed with each other, the first metal particles being made of a first metal which is a base material of the internal electrodes, the second metal particles being made of a second metal that is more oxidizable than the first metal, and the internal electrodes are formed in the firing step in the following manner. The second metal particles located near the interfaces between the metal thin-films and the green ceramic sheets are selectively oxidized and the second metal particles located in inner portions of the metal thin-films are deposited outside the metal thin-films and are oxidized such that oxide layers including the oxidized second metal particles are formed along the interfaces and the first metal particles are sintered such that the first metal particles grow along the oxide layers.

In another preferred embodiment of the present invention, the metal thin-films are formed in the metal thin-film-forming step so as to have a multilayer structure including a first metal layer and a second metal layer abutting the first metal layer, the first metal layer being made of a first metal which is a base material of the internal electrodes, the second metal layer being made of a second metal that is more oxidizable than the first metal, and the internal electrodes are formed in the firing step in the following manner. The second metal layer is selectively oxidized into an oxide layer and metal particles included in the first metal layer are sintered such that particles of the first metal grow along the oxide layer.

The first metal is preferably nickel and the second metal is preferably chromium, for example.

The thin film-forming process is preferably a vapor deposition process, for example.

A monolithic ceramic electronic component according to another preferred embodiment of the present invention includes a plurality of stacked ceramic layers and internal electrodes extending along interfaces between the ceramic layers. In the monolithic ceramic electronic component, the internal electrodes are made of a first metal defining a base material and include segregation phases which are located at the interfaces between the ceramic layers and the internal electrodes and which include an oxide of a second metal that is more oxidizable than the first metal.

In a method for manufacturing a monolithic ceramic electronic component according to various preferred embodiments of the present invention, internal electrodes are formed in a firing step in the following manner. Oxide layers including an oxide of a second metal are formed along the interfaces between metal thin-films and green ceramic sheets and metal particles made of a first metal are sintered such that particles of the first metal grow along the oxide layers. That is, the particles of the first metal are prevented from growing in the thickness direction of the metal thin-films. This allows the internal electrodes to have a reduced thickness and allows the internal electrodes to have enhanced coverage.

In a monolithic ceramic electronic component according to various preferred embodiments of the present invention, segregation phases which include an oxide of a second metal are located at the interfaces between the ceramic layers and the internal electrodes. Thus, the second metal does not diffuse in the ceramic layers and properties of the monolithic ceramic electronic component can be prevented from being deteriorated or undesirably being varied.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a sectional view of a monolithic ceramic capacitor as an example of a monolithic ceramic component according to a preferred embodiment of the present invention.

FIGS. 2(1)-2(3) are sectional views illustrating steps prior to the formation of internal electrodes 13 in a preferred embodiment of the present invention.

FIGS. 3(1)-3(3) are illustrations describing another preferred embodiment of the present invention and correspond to FIGS. 2(1)-2(3).

FIGS. 4(1) and 4(2) are sectional views which illustrate steps prior to the formation of internal electrodes according to the related art.

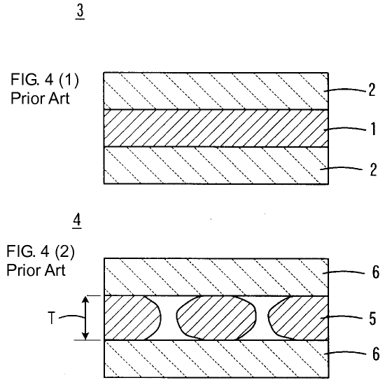

### DETAILED DESCRIPTION OF PREFERRED EMBODIMENTS

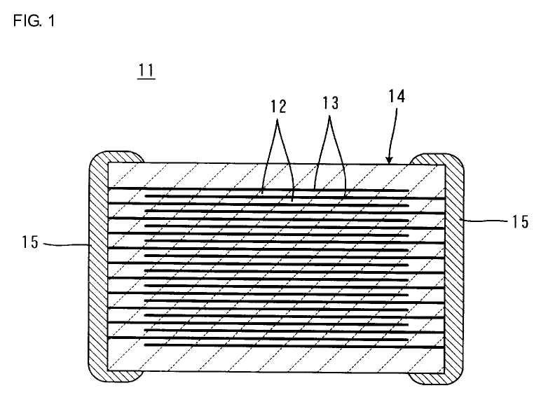

FIG. 1 is a sectional view of a monolithic ceramic capacitor 11 as an example of a monolithic ceramic electronic component according to a preferred embodiment of the present invention.

The monolithic ceramic capacitor 11 includes a sintered compact 14 including a plurality of stacked ceramic layers 12 and internal electrodes 13 extending along interfaces between the ceramic layers 12 and external electrodes 15 disposed on end surfaces of the sintered compact 14 that are opposed to each other. The internal electrodes 13 are electrically connected to one of the external electrodes 15. The internal electrodes 13 electrically connected to one of the external electrodes 15 and the internal electrodes 13 electrically connected to the other one are alternately arranged in the lamination direction of the sintered compact 14.

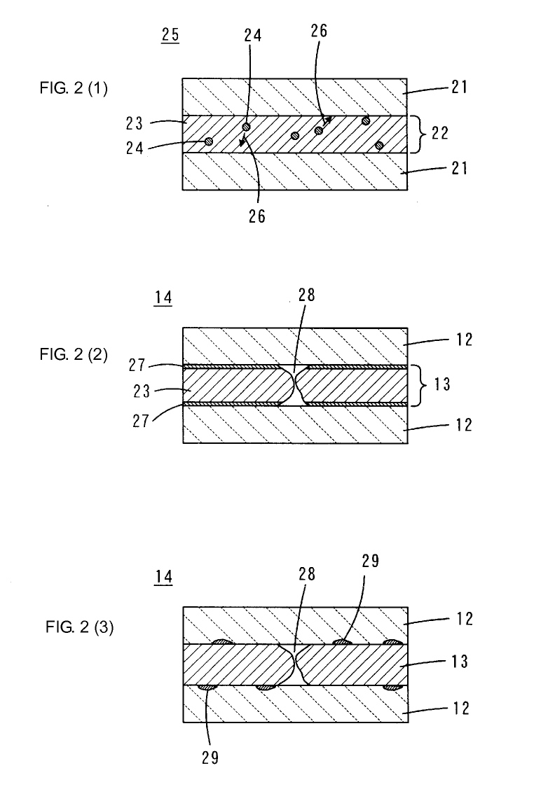

According to a first preferred embodiment of the present invention, in order to manufacture the monolithic ceramic capacitor 11, green ceramic sheets 21 are prepared as shown in FIG. 2(1). The green ceramic sheets 21 are provided to be sintered into the ceramic layers 12.

Metal thin-films 22 to be formed into the internal electrodes 13 are formed on the green ceramic sheets 21 by a thin film-forming process, such as a vapor deposition process or a sputtering process, for example. In view of productivity, the vapor deposition process is preferably used. In the metal thin-film-forming step, the metal thin-films 22 are formed such that first metal particles 23 and second metal particles 24 are mixed with each other, the first metal particles 23 being made of a first metal which is a base material of the internal electrodes 13, the second metal particles 24 being made of a second metal that is more oxidizable than the first metal.

In FIGS. 2(1)-2(3), each of the first metal particles 23 is not shown but regions including the first metal particles 23 distributed therein are shown as “first metal particles 23”.

Where the metal thin-films 22 have been formed by the thin film-forming process, the second metal particles 24 are uniformly distributed in the regions including the first metal particles 23. The first metal, which is included in the first metal particles 23, is preferably nickel, for example. The second metal, which is included in the second metal particles 24, is preferably chromium, for example.

The green ceramic sheets 21 having the metal thin-films 22 formed as described above are stacked and pressed, whereby an unfired green compact 25 is obtained as shown in FIG. 2(1).

The green compact 25 is fired, whereby the sintered compact 14 is obtained. In the firing step, an atmosphere gas for firing flows into spaces between the metal thin-films 22 and the green ceramic sheets 21, and therefore, the second metal particles 24 located near the interfaces therebetween included in the metal thin-films 22 are selectively oxidized. This is because the second metal is more oxidizable than the first metal.

The second metal particles 24 which are located in inner portions of the metal thin-films 22 migrate toward the interfaces between the green ceramic sheets 21 and the metal thin-films 22 as indicated by an arrow 26 in FIG. 2(1). The reason for the migration thereof is unclear. However, the sintering of the first metal particles 23 probably causes the migration of the second metal particles 24 or a concentration gradient established by the oxidation of the second metal particles 24 located near the interfaces and the diffusion of the second metal due to the concentration gradient probably cause the migration of the second metal particles 24. The second metal particles 24 deposited at the interfaces are oxidized with the atmosphere gas, whereby oxide layers 27 (see FIG. 2(2)) including the oxidized second metal particles 24 are formed along the interfaces between the metal thin-films 22 and the green ceramic sheets 21.

The progress of the firing step promotes the growth of the first metal particles along the oxide layers 27. This prevents the first metal particles from growing in the thickness direction of the metal thin-films 22. Therefore, the first metal particles 23 are prevented from forming beads and are sintered, whereby the internal electrodes 13 are formed as shown in FIG. 2(2).

When the first metal particles 23 are sintered, slight beads are formed in regions that do not have oxide layers 27 and therefore spaces 28 are created as shown in FIG. 2(2). However, the spaces 28 do not cause any serious problems because the spaces 28 are small in size and number.

The further progress of the firing step allows oxides of the second metal, which are included in the oxide layers 27, to concentrate at portions of the interfaces between the oxide layers 27 and the ceramic layers 12 and to concentrate in the spaces 28, whereby segregation phases 29 (see FIG. 2(3)) are formed at the interface therebetween.

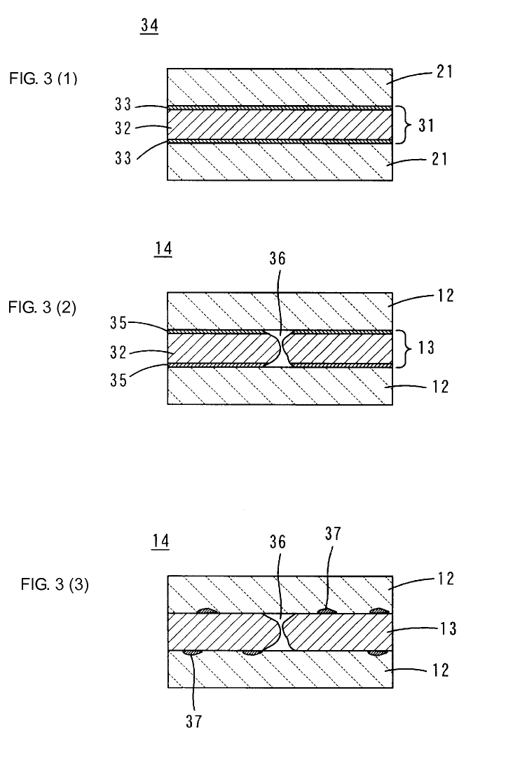

FIGS. 3(1)-3(3) illustrate a second preferred embodiment of the present invention and correspond to FIGS. 2(1)-2(3). In FIGS. 3(1)-3(3), elements corresponding to those shown in FIGS. 2(1)-2(3) are represented by the same reference numerals as those used in FIGS. 2(1)-2(3) and will not be described in detail below.

As shown in FIG. 3(1), green ceramic sheets 21 are prepared. Metal thin-films 31 to be formed into internal electrodes 13 are formed on the green ceramic sheets 21 by a thin film-forming process. The metal thin-films 31 each have a multilayer structure including a first metal layer 32 and second metal layers 33 abutting the first metal layer 32, the first metal layer 32 being made of a first metal which is a base material of the internal electrodes 13, the second metal layers 33 being made of a second metal that is more oxidizable than the first metal.

In this preferred embodiment, one of the second metal layers 33 is formed on one of the green ceramic sheets 21, the first metal layer 32 is formed thereon, and another one of the second metal layers 33 is formed thereon. However, it is not essential that the first metal layer 32 is sandwiched between the second metal layers 33. Alternatively, the second metal layers 33 may be formed in contact with either one of the principal surfaces of the first metal layer 32. In this case, the vertical relationship between the first metal layer 32 and the second metal layers 33 is not particularly limited.

In this preferred embodiment, the first metal, which is included in the first metal layer 32, is preferably nickel and the second metal, which is included in the second metal layers 33, is preferably chromium, for example.

The green ceramic sheets 21 having the metal thin-films 31 formed as described above are stacked and pressed, whereby an unfired green compact 34 is obtained as shown in FIG. 3(1).

The green compact 34 is fired, whereby a sintered compact 14 is obtained. In the firing step, the second metal layers 33, which are made of the second metal, are selectively oxidized into oxide layers 35 as shown in FIG. 3(2).

The progress of the firing step allows metal particles included in the first metal layer 32 to be sintered such that particles of the first metal, which are included in the first metal layer 32, grow along the oxide layers 35, that is, the first metal particles are prevented from growing in the thickness direction of the metal thin-films 31, whereby the internal electrodes 13 are formed.

When the metal particles included in the first metal layer 32 are sintered, the first metal layer 32 is slightly broken into beads, and therefore, spaces 36 are created as shown in FIG. 3(2). However, the spaces 36 do not cause any serious problem because the spaces 36 are small in size and number.

The further progress of the firing step allows oxides of the second metal, which are included in the oxide layers 35, to concentrate at portions of the interfaces between the oxide layers 35 and the ceramic layers 12 and to concentrate in the spaces 36, whereby segregation phases 37 (see FIG. 3(3)) are formed at the interface therebetween.

Experiments performed to confirm advantages of preferred embodiments of the present invention will now be described.

Nickel was used as a first metal that was a base material of internal electrodes. Chromium was used as a second metal that is more oxidizable than the first metal. In order to form the internal electrodes from nickel and chromium by vapor deposition such that the internal electrodes had concentrations shown in the “chromium concentration” row of Table 1, metal thin-films included in samples were formed on green ceramic sheets such that nickel and chromium were melted in an evaporation crucible. In each sample, the thickness of the metal thin-films was determined by XRF analysis to be about 160 nm as shown in Table 1.

The green ceramic sheets having the metal thin-films formed as described above were stacked and then isostatically pressed at a temperature of about 70° C. for about five minute with a pressure of about 50 MPa, followed by degreasing at a temperature of about 280° C. and then firing at a temperature of up to about 1250° C. for about two hours.

Each sample obtained by firing as described above was measured for “fired-electrode thickness”, “fired-element thickness”, and “coverage” as shown in Table 1 by observing the polished surface of the sample with a microscope.

TABLE 1

| Samples | 1 | 2 | 3 | 4 |
|---|---|---|---|---|
| Chromium | 0 | About 2.4 | About 1.2 | About 0.4 |
| concentration | | weight | weight | weight |
| | | percent | percent | percent |
| Layer | 160 nm | 160 nm | 160 nm | 160 nm |
| thickness | | | | |
| Fired- | 0.29 μm | 0.14 μm | 0.16 μm | 0.17 μm |
| electrode | | | | |
| thickness | | | | |
| Fired-element | 0.92 μm | 0.95 μm | 0.99 μm | 0.96 μm |
| thickness | | | | |
| Coverage | 64% | 72% | 89% | 91% |
| | | (90% or more | | |
| | | at a center | | |
| | | portion) | | |

As shown in Table 1, Samples 2 to 4, which include chromium, have a smaller “fired-electrode thickness” and have a greater coverage than Sample 1, which does not include chromium. It has been confirmed that Sample 2 has a center portion with a coverage of at least about 90%.

In order to identify the location of chromium, Samples 2 to 4, which included chromium, were subjected to TEM analysis and WDX analysis, whereby the findings below were obtained.

No segregation of chromium was observed in the formed metal thin-films and chromium was uniformly distributed therein. No chromium was detected in inner portions of the fired internal electrodes or at the interfaces between portions separated from each other by the breakage of the fired internal electrodes, that is, the amount of chromium was below the detection limit of TEM or WDX analysis. Nickel and chromium were segregated in crystal grains in portions of ceramic layers that were located near the internal electrodes. No chromium was detected in inner portions of the ceramic layers other than the crystal grains in the ceramic layer portions or the interfaces between the ceramic layers and the internal electrodes, that is, the amount of chromium was below the detection limit of TEM or WDX analysis.

While the present invention has been described above with reference to the monolithic ceramic capacitor as an example, the present invention is not limited to the monolithic ceramic capacitor and is applicable to any suitable monolithic ceramic electronic components.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method for manufacturing a monolithic ceramic electronic component, comprising:
a step of preparing green ceramic sheets;
a metal thin film-forming step of forming metal thin-films, to be formed into internal electrodes, on the green ceramic sheets by a thin film-forming process;
a step of preparing a green compact such that the green ceramic sheets including the metal thin-films are stacked and pressed; and
a firing step of firing the green compact; wherein
the metal thin-films are formed in the metal thin-film-forming step such that first metal particles and second metal particles are mixed with each other, the first metal particles being made of a first metal which is a base material of the internal electrodes, the second metal particles being made of a second metal that is more oxidizable than the first metal, and the internal electrodes are formed in the firing step as follows:
the second metal particles located near interfaces between the metal thin-films and the green ceramic sheets are selectively oxidized;
the second metal particles located in inner portions of the metal thin-films are deposited outside the metal thin-films and oxidized such that oxide layers including the oxidized second metal particles are formed along the interfaces;
the first metal particles are sintered such that the first metal particles grow along the oxide layers.

2. The monolithic ceramic electronic component-manufacturing method according to claim 1, wherein the first metal is nickel and the second metal is chromium.

3. The monolithic ceramic electronic component-manufacturing method according to claim 1, wherein the thin film-forming process is a vapor deposition process.

4. A method for manufacturing a monolithic ceramic electronic component, comprising:
a step of preparing green ceramic sheets;
a metal thin film-forming step of forming metal thin-films, to be formed into internal electrodes, on the green ceramic sheets by a thin film-forming process;
a step of preparing a green compact such that the green ceramic sheets having the metal thin-films are stacked and pressed; and
a firing step of firing the green compact; wherein
the metal thin-films are formed in the metal thin-film-forming step so as to have a multilayer structure including a first metal layer and a second metal layer abutting the first metal layer, the first metal layer being made of a first metal which is a base material of the internal electrodes, the second metal layer being made of a second metal that is more oxidizable than the first metal, and the internal electrodes are formed in the firing step as follows:
the second metal layer is selectively oxidized into an oxide layer; and
metal particles included in the first metal layer are sintered such that particles of the first metal grow along the oxide layer.

5. The monolithic ceramic electronic component-manufacturing method according to claim 4, wherein the first metal is nickel and the second metal is chromium.

6. The monolithic ceramic electronic component-manufacturing method according to claim 4, wherein the thin film-forming process is a vapor deposition process.

7. A monolithic ceramic electronic component comprising:
a plurality of stacked ceramic layers; and
internal electrodes extending along specific interfaces between the ceramic layers; wherein
the internal electrodes include a first metal which is a base material and segregation phases which are located at interfaces between the ceramic layers and the internal electrodes and which include an oxide of a second metal that is more oxidizable than the first metal.
